(19) United States
(12) Patent Application Publication
(10) Pub. No.: US 2015/0007290 A1
(43) Pub. Date: Jan. 1, 2015

(54) Stimuli-Response-Driven Authentication Mechanism

(71) Applicants: Franck Franck, Dublin (IE); Eric B. Jul, Roskilde (DK)

(72) Inventors: Franck Franck, Dublin (IE); Eric B. Jul, Roskilde (DK)

(21) Appl. No.: 13/929,538

(22) Filed: Jun. 27, 2013

(51) Int. Cl. G06F 21/32

(52) U.S. Cl. CPC G06F 21/32
USPC 726/7

(57) ABSTRACT

A stimuli-response-driven authentication mechanism is implemented in a communication system including a user platform and a trusted external platform operably connected to an authentication platform. The authentication mechanism is implemented in an initialization phase and authentication phase. In the initialization phase, a user is exposed to a first set of external stimuli (e.g., image data) and data characterizing the user's physiological responses are obtained (in a high-security implementation, by the trusted external platform). In the authentication phase, the user is exposed to a second set of external stimuli (e.g., a subset of the first set) and data characterizing the user's physiological responses are obtained, and instances of the authentication data are compared to corresponding instances of the initialization data to authenticate the user.

### BACKGROUND OF THE INVENTION

1. Field of the Invention

This invention relates generally to authentication mechanisms for use in providing authenticated access control (i.e., to grant or deny access of an individual to some resource).

2. Statement of the Problem

Authenticated access control is a problem for almost any business or entity that has resources to protect. Access control is typically provided by an authentication mechanism that is used to identify an individual with some degree of confidence and to grant or deny access to some resource depending on the privileges of that individual. For example and without limitation, authenticated access control may be used to control access to communication platforms or content (e.g., coincident to web-based customer transactions) or physical property or borders.

Generally, the greater the value of the resource, the greater the need for highly-secure, authenticated access control and the greater complexity or sophistication of the authentication mechanism that is used to identify an individual attempting to access the resource. Most highly-secure access control solutions in use today rely on what is known as two-factor authentication. That means that to prove one's identity to the system, two different factors must be used together. Usually the two factors are something you have (e.g., key card or RSA token) and something you know (e.g., a password or PIN). Generally, such systems are considered highly secure because there is some likelihood that one's keycard may be lost or stolen, and there is some likelihood one's password or PIN may be intercepted, but it is statistically unlikely that an adversary could obtain both a person's keycard and PIN to gain access to a particular resource. Even so, however, such systems are vulnerable to targeted attacks (e.g., hacking, keyboard-logging, surveillance or physical force) or misuse (i.e., where the individual himself gains access to the resource for illicit purposes).

More recently, very secure systems have moved toward biometric security—something you are—for example using mechanisms such as fingerprint or iris scans to verify an individual's identity. Presently, however, although biometric security is promising in concept, known biometric mechanisms may be circumvented by falsification (e.g., with fake glass eyes, rubber fingerprints), physical coercion (e.g., forcing an individual to come with them to the fingerprint or iris scanner) or misuse. Security can be enhanced by deploying biometric scanners in a protected and secured environment (e.g., using trusted hardware, with armed guards or the like) but such measures are impractical and cost-prohibitive for most access control applications. Another problem with known biometric systems is that they are hard to revoke and reissue, should they become compromised. For example, a biometric authentication system might make a compromised fingerprint or an iris scan invalid, but the system is limited in how many times it may reissue a new fingerprint or iris scan since at best an individual will have ten fingerprints and two irises.

Yet another problem is that in some instances, a less-secure authentication mechanism may be tolerable, or even preferred relative to a more highly-secure authentication mechanism, so as to offer less complexity, sophistication or cost, or to impose less burden on the individual attempting to access a resource. Moreover, it is contemplated that a “tuneable” authentication mechanism may be useful, which may be dynamically changed to accommodate a range of security levels depending on the application. Presently, however, known authentication mechanisms have little flexibility in adapting for example, from a highly-secure to a less-secure solution or dynamically adjusting to multiple security levels.

### SUMMARY OF THE SOLUTION

These problems are addressed by providing a stimuli-response-driven authentication mechanism, a form of biometric authentication that verifies a person's identity by measuring the person's physiological responses to a set of randomly selected external stimuli. The physiological responses characterize at least in part the person's involuntary or subconscious response to the authentication stimuli, which (depending on application) are contemplated to be nearly invulnerable to falsification, physical coercion or misuse relative to heretofore known biometric authentication mechanisms. The stimuli-response-driven authentication mechanism may be adapted for virtually any security level including highly-secure and less-secure applications and/or may be dynamically adjusted to accommodate multiple security levels.

In one embodiment, there is provided an apparatus comprising a memory and at least one processor, the at least one processor coupled to the memory and configured to: coincident to an initialization protocol, obtain biometric initialization data characterizing at least in part, a user's physiological responses to a first set of external stimuli; coincident to an authentication protocol: obtain biometric authentication data characterizing at least in part, a user's physiological responses to a second set of external stimuli, wherein the second set includes one or more instances of external stimuli selected from the first set; compare the biometric authentication data to corresponding instances of the biometric initialization data; and authenticate the user if one or more instances of the biometric authentication data sufficiently corresponds to corresponding instances of the biometric initialization data.

In another embodiment, there is provided a method, performed by one or more of a user platform, a trusted external platform, and an authentication platform residing remotely from the user platform, in accordance with a communication system including a user platform and optionally, a trusted external platform operably connected to the authentication platform. The method comprises coincident to an initialization protocol: obtaining biometric initialization data characterizing at least in part, a user's physiological responses to a first set of external stimuli; coincident to an authentication protocol: obtaining biometric authentication data characterizing at least in part, a user's physiological responses to a second set of external stimuli, wherein the second set includes one or more instances of external stimuli selected from the first set; comparing the biometric authentication data to corresponding instances of the biometric initialization data; and authenticating the user if one or more instances of the biometric authentication data sufficiently corresponds to corresponding instances of the biometric initialization data.

In yet another embodiment, there is provided a method, performed by an authentication platform, in accordance with a communication system including a user platform operably connected to the authentication platform. The method comprises the authentication platform receiving indicia of an access control event, whereby authentication is required for controlling user access to a resource; identifying an authentication security level associated with the event; identifying a stimuli-response-based authentication protocol corresponding to the authentication security level; and applying the stimuli-response-based authentication protocol to determine user access to the resource.

### DESCRIPTION OF THE DRAWINGS

FIG. 1 is a block diagram of a communication system implementing a stimuli-response-driven authentication mechanism according to embodiments of the present invention.

FIG. 2 is a flowchart showing steps performed to execute an initialization protocol associated with stimuli-response-driven authentications according to embodiments of the present invention.

FIG. 3 is a flowchart showing steps performed to execute an authentication protocol associated with stimuli-response-driven authentications according to embodiments of the present invention.

FIG. 4 is a flowchart showing steps performed to implement a stimuli-response-driven authentication mechanism that is adjustable to accommodate multiple security levels.

### DESCRIPTION OF THE PREFERRED EMBODIMENTS

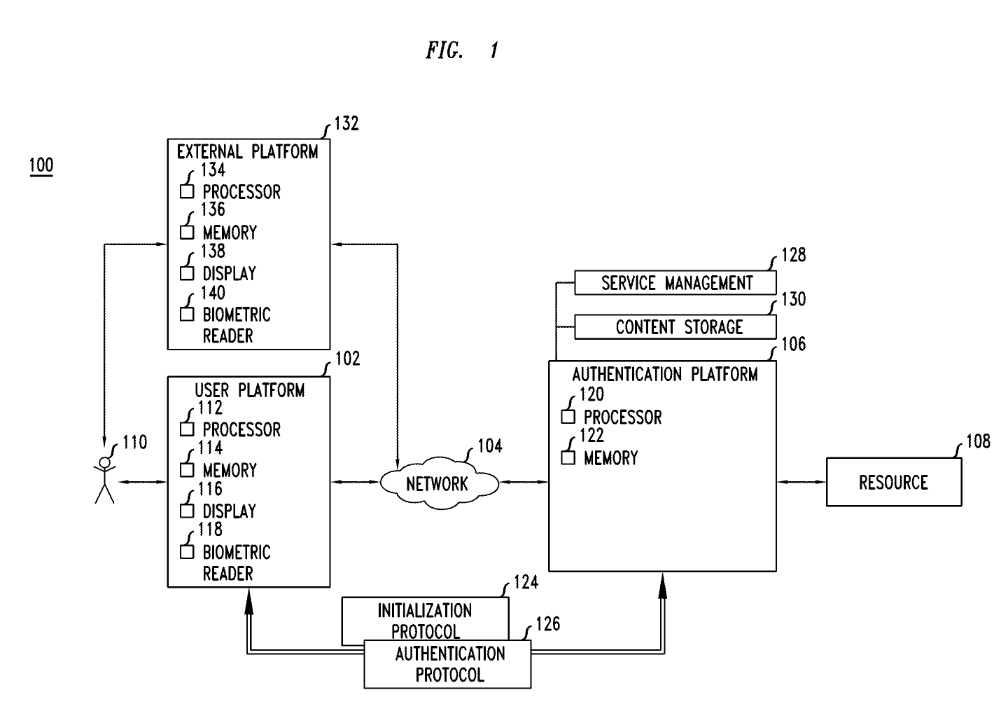

FIG. 1 illustrates a communication system 100 capable of implementing a stimuli-response-driven authentication mechanism according to embodiments of the present invention. The communication system 100 includes a user platform 102 interconnected by a communication network 104 to an authentication platform 106 which, in turn, is connected to a destination resource 108. The user platform 102 may comprise, for example and without limitation, a tablet computer, laptop computer, desktop computer or mobile computing device, nominally including a web brower, and which in one embodiment, is subject to operation by a user 110 (i.e., person) to interact with the authentication platform 106 to authenticate the user 110 and gain access to the resource 108. The destination resource 108 may comprise, for example and without limitation, a communication resource such as a web server hosting a website with which the user is conducting an online transaction; or a physical resource such as a doorway or gateway controlling access to physical property or controlling authorization to cross physical borders. Alternatively, in a lower-security implementation, the user platform 102 may operate independently to authenticate the user 110 and gain access to the resource 108.

The authentication platform 106 may comprise, for example and without limitation, a computer device or software application residing remotely from the user platform that executes transactions or segments of transactions to implement stimuli-response-driven authentications. The authentication platform 106 is a functional element that may reside within one or more physical devices and may be colocated or remote from the resource 108. In one embodiment, transactions or segments of transactions associated with stimuli-response-driven authentications are executed by the authentication platform 106 in conjunction with the user platform 102. According to embodiments of the invention, stimuli-response-driven authentications may be adapted to accommodate any of multiple security levels, and the particular functions and uses of the respective platforms may vary depending on the security level.

Optionally, the communication system may include a trusted external platform 132 (e.g., under control of a trusted authentication authority) that is interconnected by the communication network 104 to the authentication platform 106. In one embodiment, transactions or segments of transactions associated with stimuli-response-driven authentications are executed in part by the external platform 132 in conjunction with the authentication platform 106.

The network 104 comprises generally any communication medium operable to link the user platform 102 (and if applicable, the external platform 132) to the authentication platform 106 and destination resource 108. The network 104 may comprise, without limitation, an IP Multimedia Subsystem (IMS) network, a wireless network (e.g., Wi-fi, CDMA-based, GSM-based or LTE-based network), a circuit-switched network, a packet-based network (IP network) or another type of network.

The user platform 102, authentication platform 106 and external platform 132 each include a processor and memory for effecting transactions or segments of transactions between the respective platforms to execute stimuli-response-driven authentications. As shown, the user platform 102 includes processor 112 and memory 114; the authentication platform 106 includes processor 120 and memory 122; and the external platform 132 includes processor 134 and memory 136. Generally, the processors 112, 120, 134 are operable to execute respective program code (e.g., including but not limited to operating system firmware/software and application software) stored in the respective memory 114, 122, 136, the execution of which may depend in part from commands issued from the user 110 or in the case of the external platform 132, a trusted authentication authority (not shown).

As shown, the user platform 102 and external platform 132 further include a display and a biometric reader. The user platform includes display 116 and biometric reader 118; and the external platform includes display 138 and biometric reader 140.

According to embodiments of the present invention, the transactions or segments of transactions carried out between the respective platforms include an initialization protocol 124 and an authentication protocol 126 associated with stimuli-response-driven authentications. In one embodiment, the stimuli-response-driven authentications are based on visual stimuli (e.g., displayed by the display 116 or 138) and the user's physiological responses to the visual stimuli (e.g., including without limitation, heart rate, blood pressure, skin conductivity, body temperature, blink rate, measured by the biometric reader 118 or 140). As will be appreciated, the displays 116, 138 may be implemented in virtually any display technology, either presently known or devised in the future. Similarly, the biometric readers 118, 140 may be implemented to measure virtually any type of physiological responses, using virtually any biometric technology either presently known or devised in the future.

The authentication platform 106 is operably connected to and consults one or more functional elements when carrying out the respective processes. As shown, the functional elements include a service management element 128 and a content storage element 130. As will be appreciated, the respective functional elements may be implemented in one or more physical devices and may be linked to the user platform 102 and/or external platform 132 as well as the authentication platform 106. In one embodiment, the service management element 128 establishes client accounts, maintains records and generates reports associated with different users 110 (including, for example, user IDs, contact information, usage data, service features and/or restrictions) and resources 108 (including, for example, security levels, restrictions or the like); and the content storage element 130 stores content (including, for example, visual stimuli and physiological responses indexed to user IDs).

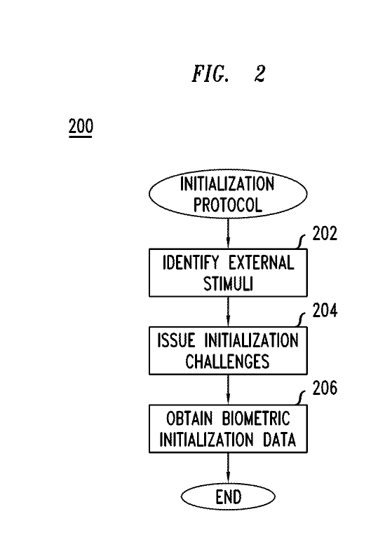

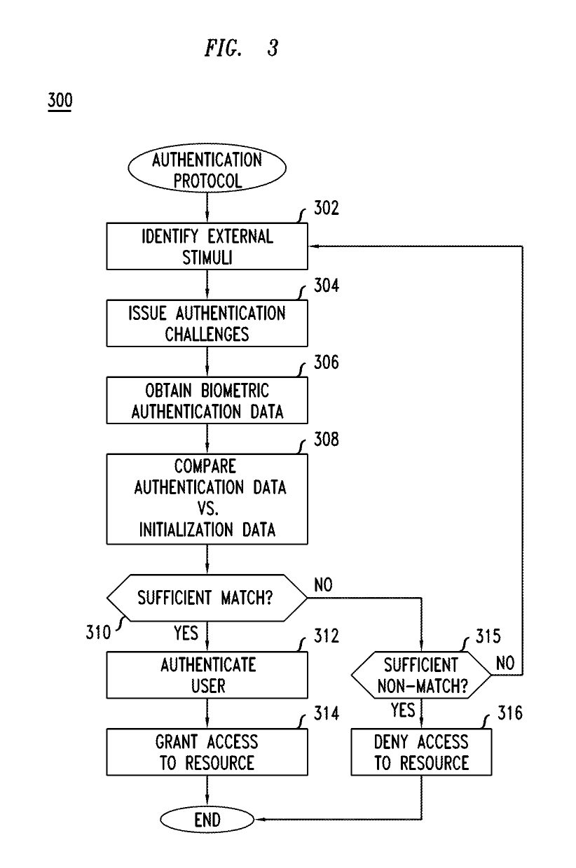

FIG. 2 is a flowchart showing steps performed to execute the initialization protocol 124 associated with stimuli-response-driven authentications according to embodiments of the present invention. Generally, the initialization protocol 124 is a preliminary data gathering phase whereby the user is exposed to a first set of external stimuli, and a database of biometric initialization data is obtained characterizing at least in part, a user's physiological responses to the first set of external stimuli. Thereafter, in an authentication phase, the user is exposed to a second set of external stimuli, defining biometric authentication data, and the biometric authentication data is compared to corresponding instances of the biometric initialization data to verify (or not verify) the identity of the user. The authentication protocol will be described in greater detail in relation to FIG. 3.

The steps of FIG. 2 may be performed, for example, by the authentication platform 106 in conjunction with the user platform 102 (under operation of the user 110) or optionally, by the authentication platform in conjunction with the external platform 132 (under operation of a trusted authentication authority). Alternatively, the steps of FIG. 2 may be performed by the user platform 102 or external platform 132 independently of the authentication platform. As will be appreciated, the determination of which one or more of the authentication platform, user platform or external platform executes the steps of FIG. 2 is an implementation decision that depends on the desired level of security.

In one example, a highly secure authentication solution might involve obtaining initialization data by means of a user sitting down in front of the external platform 132 (e.g., using trusted training hardware), in a controlled environment (e.g., at an authorized site controlled by an authenticating authority), and the external platform sending the initialization data to the authentication platform for later use in performing the authentication protocol. Alternatively, the external platform may itself maintain the initialization data and later perform the authentication protocol.

In another example, a less-secure, less-burdensome authentication solution may allow a user to utilize one's own user platform 102 to obtain initialization data and either send it to the authentication platform for later use in performing the authentication protocol, or the user platform may maintain the initialization data itself and later perform the authentication protocol.

At step 202, a set of external stimuli (i.e., the “first set”) associated with the initialization protocol is identified.

In one embodiment (e.g., a highly secure solution), in the case where the initialization data is obtained by the trusted external platform 132, the first set of images may be generated or selected by the trusted external platform 132 or may be generated or selected by the authentication platform and communicated to the external platform 132. Alternatively (e.g., a less secure solution), in the case where the initialization data is obtained by the user platform 102, the first set of images may be generated or selected by the user platform 102 or may be generated or selected by the authentication platform and communicated to the user platform 102.

In one embodiment, this first set of external stimuli is selected from a library of image content of various categories, which are contemplated to yield different physiological reactions and/or emotions for different individual users. For example, some images may be emotionally neutral (e.g., a desk, a road, a house), some culturally laden (e.g., a church, a handgun, a man with a turban), some personally affective for the user (e.g., the user's spouse, pet, dream car, a cherished food or item), some abstract pictures (e.g., Picasso artwork, random diagrams, a number) and some morally charged (e.g., a pickpocket, a riot, a young person drinking alcohol). The library of image content is not limited to these categories, it is just used to illustrate prospective use of a wide variety of different content in the initialization phase. Advantageously, the user's responses to each category will be largely independent of responses to other categories. This is a statistical consideration that will allow the system to make allowances for changes in mood in the user. In one embodiment, the selected “first set” of image content that is to be used in the initialization phase (and hence, the image library from which the first set is selected) should advantageously be very large. Exactly how large depends on the required level of security, but as will be described in relation to FIG. 3, a “second set”of images may be used in the authentication phase, which may be only a subset of the first set, and that second set should be large enough to bring the statistical uncertainty into a desired range. Optionally, one way to generate a large set of images is to build an image generator that composes new images by randomly picking various partial elements of an image and then putting them together.

At step 204, the user is exposed to the first set of external stimuli via one or more initialization challenges. Depending on implementation, the initialization challenges may be issued by the authentication platform and communicated to the external platform 132 or the user platform 102, or the initialization challenges may be issued independently by the external platform 132 or user platform 102.

In one embodiment, the first set of external stimuli are displayed in randomized order during the initialization challenges, and may be displayed several times in order to obtain a stable baseline measurement. It is noted that a person's responses toward the external stimuli will probably change over time. For example, a user may divorce their spouse, changing a previous “love” response to an “anger” response, or the user's social or political views may change over time, changing a previous “indifferent” response to teenage drinking to one of “outrage.” Therefore, it is contemplated that it will be necessary to periodically “re-initialize” the system. How often this is required depends on the required level of security and the size of the training set.

At step 206, responsive to the user having undergone the initialization challenges, a database of biometric initialization data is obtained characterizing at least in part, a user's physiological responses to the first set of external stimuli. As has been noted, depending on implementation, the initialization data may be obtained by the trusted external platform 132 (a highly secure solution) or the user platform 102 (a less secure solution). Thereafter, the external platform 132 or the user platform 102 may communicate the initialization data to the authentication platform 106 (e.g., in the case where the authentication platform will later execute the authentication protocol) or may maintain the initialization data itself (e.g., in the case that the external platform or user platform will later execute the authentication protocol).

Advantageously, the physiological responses will be outside the conscious control of the user, so that the user may not “fake” the responses. The biometric initialization data is indicated as characterizing the user's physiological responses “at least in part” because although it contains biometric data obtained responsive to external stimuli, it is understood that the biometric data is partially attributable to the user's nominal physical characteristics and is accordingly interpreted in context to the user's nominal physical characteristics. For example, a measured heart rate of 80 beats per minute responsive to a particular image may represent a significant physiological reaction for an example user having a nominal heart rate of 65 beats per minute, yet it is only the increase in heart rate (e.g., 15 beats per minute) that is attributable to the user's response to the image. Therefore, the biometric initialization data may comprise measured response data that is representative of the user's physiological reaction (e.g., 80 bpm), recognizing that it only partially characterizes the user's response to the stimuli. Alternatively or additionally, the biometric initialization data may include indicia of the user's nominal physical characteristics (e.g., 65 bpm) to supplement the measured response data, or may include normalized data (e.g., +15 bpm) indicative of the user's physiological reaction relative to the user's nominal physical characteristics.

As still another alternative, the biometric initialization data may comprise data that is representative of the user's physiological reaction, but which has been transformed in some manner relative to the original form of the measured response data. For example and without limitation, the biometric initialization data could be derived by Fourier transform, differentiation, or the like of the measured response data. As will be appreciated, derivation of the biometric initialization data from the measured response data may be accomplished by the trusted external platform, user platform or authentication platform.

FIG. 3 is a flowchart showing steps performed to execute the authentication protocol 126 associated with stimuli-response-driven authentications according to embodiments of the present invention. Generally, the authentication protocol describes a second phase, occurring some time after the initialization protocol (e.g., days, weeks, months) whereby the user is exposed to a second set of external stimuli, defining biometric authentication data, and the biometric authentication data is compared to corresponding instances of the biometric initialization data to verify (or not verify) the identity of the user.

In one embodiment, the steps of FIG. 3 are performed by the user platform 102 (under operation of the user 110) either independently or in conjunction with the authentication platform 106. The user platform 102 need not (and likely will not) be a “trusted” platform. This facilitates direct user-to-user authentication (for example, money transfers) very easily, since personal devices can be used to securely identify individuals. Further, embodiments using personal devices can be deployed en masse at low cost, despite needing a central authentication server. Alternatively, the steps of FIG. 3 could be performed by an external terminal (trusted or untrusted) independently or in conjunction with the authentication platform. It is noted, the terminal that executes the authentication protocol need not be the same terminal that executed the initialization protocol. In any case, the terminal that executes the authentication protocol includes an image screen (e.g., display 116) for displaying the second set of images and a biometric reader (e.g., biometric reader 118) that can collect the user's physiological responses from the second set of images.

At step 302, the set of external stimuli (i.e., the “second set”) associated with the authentication protocol is identified. In one embodiment, this “second set” of external stimuli is selected from the “first set” of image content associated with the initialization phase, and hence the second set includes one or more instances of external stimuli common to the first set. In one embodiment, in the case where the initialization data is maintained by the authentication platform 106, the authentication platform selects the second set of images for use in the authentication protocol and communicates it to the one of the trusted external platform or user platform, one at a time, in randomized order, responsive to requests from the external platform or user platform. Alternatively, in the case where the initialization data is maintained by the external platform or user platform, the external platform or user platform may select the second set of images for use in the authentication protocol.

Optionally, the second set may include one or more instances of image content that is not included in the first set, but which are composed of categories or themes that are sufficiently compatible with corresponding images in the first set that they may be expected to yield corresponding physiological reactions as the first set. For example, a photograph of a user's spouse used in the authentication phase (although not used in the initialization phase) might be considered sufficiently compatible with a different photograph used in the initialization phase if both photographs are expected to yield the same or similar physiological reactions.

At step 304, the user platform or external platform issues one or more authentication challenges to expose the user to the second set of external stimuli. In one embodiment, the instances of images associated with the authentication challenges are displayed briefly (e.g., on the order of seconds or fractions of seconds), and appear in randomized order, so that the user is not able to predict consecutive images. Depending on implementation, the order and timing of the images may correspond to the order and timing of images as the user platform or external platform receives them from the authentication platform, or the user platform or external platform may itself determine the order and timing of the images.

At step 306, responsive to issuing the authentication challenges, the user platform or external platform obtains biometric authentication data characterizing at least in part, the user's physiological responses to the second set of external stimuli. Similarly to the biometric initialization data, the biometric authentication data will advantageously be outside the conscious control of the user, so that the user may not “fake” the responses; and the biometric authentication data is indicated as characterizing the user's physiological responses “at least in part” because it may comprise measured response data that is representative of the user's physiological reaction but may be partially attributable to the user's nominal physiological characteristics. Further, similarly to the biometric initialization data, the biometric authentication data may comprise data that is representative of the user's physiological reaction, but which has been transformed in some manner relative to the original form of the measured response data (e.g., by Fourier transform, differentiation, or the like) for comparison to corresponding instances of biometric initialization data.

In one embodiment, coincident to obtaining the biometric authentication data, the user platform or external platform communicates the authentication data to the authentication platform (e.g., in the case where the authentication platform will authenticate the user). Depending on implementation, the user platform or external platform may communicate the authentication data to the authentication platform one instance at a time, immediately as each instance is obtained corresponding to the timing sequence of the authentication challenges; or the user platform or external platform may collect multiple instances of authentication data and send it collectively to the authentication platform. Alternatively, the user platform or external platform may itself maintain the biometric authentication data (e.g., in the case that the user platform or external platform will authenticate the user).

At step 308, the one of the authentication platform, user platform or external platform that will authenticate the user compares one or more instances of authentication data associated with the authentication challenges with corresponding instances of initialization data (i.e., associated with the same or sufficiently compatible images displayed to the user coincident to the initialization challenges) relative to predetermined guidelines that define a sufficient “match” (i.e., a degree of correspondence between the authentication data and initialization data.) Thereafter, at step 310, the authentication platform, user platform or external platform determines whether the authentication data sufficiently matches or corresponds to the corresponding initialization data. For example and without limitation, the sufficiency of correspondence between authentication data and initialization data may be defined on a per-challenge basis and/or on a cumulative basis, based on numerical thresholds and/or statistical analysis. In one example, the guidelines may specify numerical thresholds required to “pass” respective individual challenges; and may continue until enough challenges are passed, or passed with enough precision, that the authentication platform, user platform or external platform is able to determine with statistical certainty that the user is who they claim to be. As will be appreciated, the guidelines may differ corresponding to different security levels, for example, by adjusting the pass criteria of individual challenges and/or the number or percentage of overall challenges that must be passed to achieve statistical certainty at the desired security level. It is noted, therefore, multiple security levels may be accommodated by the same hardware.

If at step 310 the authentication data is determined to sufficiently match corresponding instances of the biometric initialization data according to the guidelines, the authentication platform, user platform or external platform authenticates the user at step 312 and grants the user access to the resource at step 314.

In one embodiment, if there is not a sufficient match at step 310, the authentication platform, user platform or external platform at step 315 determines whether there is a sufficient “non-match” or disparity between the authentication data and corresponding instances of biometric initialization data so as to determine with statistical certainty that the user is not who they claim to be. For example, the guidelines may specify numerical thresholds associated with failure of individual challenges, or failure on a cumulative basis based on too many failed individual challenges. If at step 315 there is determined to be sufficient “non-match” or disparity between the authentication and initialization data, the authentication platform, user platform or external platform rejects the user authentication and denies user access to the resource at step 316.

If at step 315, the authentication platform, user platform or external platform determines there is not sufficient “non-match” or disparity between the authentication and initialization data (i.e., it can not determine with statistical certainty that the user is not who they claim to be), the process returns to step 302 whereby one or more next consecutive instances of image content are identified, and step 304 the application platform, user platform or external platform issues further authentication challenges, and so forth, until such time that the user can be authenticated at step 312 or rejected at step 316.

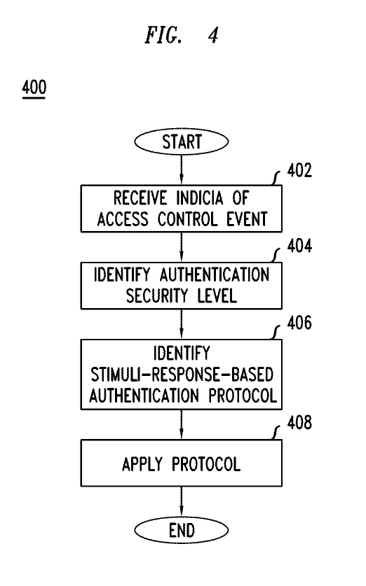

Now turning to FIG. 4, there is a flowchart showing steps performed to implement a stimuli-response-driven authentication mechanism that is adjustable to accommodate multiple security levels. In one embodiment, the steps of FIG. 4 are performed by the authentication platform 106.

At step 402, the authentication platform 106 receives indicia of an access control event. Generally, the access control event may comprise any event in which a user 110 seeks to gain access to a resource 108 comprising, for example a communication resource or physical resource, and authentication is required by the authentication platform for controlling user access to the resource. For example and without limitation, the authentication platform may receive indicia of the access control event responsive to the user operating the user platform 102 to attempt access to the resource 108, and the user platform 102 interacting with the authentication platform 106 (e.g., sending an access request) to attempt to authenticate the user for access to the resource 108. In one embodiment, the access request will include indicia of the user 110 (e.g., user ID or the like) and indicia of the resource 108 to which access is requested.

At step 404, the authentication platform 106 identifies an authentication security level associated with the event. In one embodiment, the authentication security level is determined based on a pre-determined security level of the resource 108 to which access is requested. Responsive to receiving an authentication request with indicia of the resource 108, the authentication platform consults the service management element 128 to ascertain the security level associated with the resource, and assigns an appropriate security level to the event. As will be appreciated, different security levels may be designated in any of several ways including without limitation, textual labels (“high,” “medium,” “low”), numerical labels (“1,” “2,” “3”), color codes (“red,” “orange,” “yellow”) or the like. Suffice it to say that different resources, and hence different access control events, are contemplated to have different security levels, and an appropriate security level for an event should at least equal or exceed the security level associated with the resource to which access is requested.

At step 406, the authentication platform identifies a stimuli-response-based authentication protocol corresponding to the authentication security level. In one embodiment, the stimuli-response-based authentication protocol comprises one or more authentication challenges, such as described in relation to FIG. 3, whereby the user is exposed to a set of external stimuli (e.g., image data) and biometric authentication data is obtained characterizing at least in part, the user's physiological responses to the set of external stimuli, and whereby the authentication data is compared to corresponding initialization data, obtained during an initialization process such as described in relation to FIG. 2 to verify (or not) the identity of the user. The stimuli-response-based authentication protocol further defines guidelines, such as described in relation to FIG. 3, that identify how closely the authentication data and initialization data must correspond on a per-challenge basis and/or on a cumulative basis, based on numerical thresholds and/or statistical analysis to yield a successful authentication. As noted with respect to FIG. 3, the guidelines may differ corresponding to different security levels, for example, by adjusting the pass or fail criteria of individual challenges and/or the number or percentage of overall challenges that must be passed or failed to achieve statistical certainty at the desired security level. Depending on implementation, the authentication platform may formulate the authentication protocol dynamically or may select the authentication protocol from a database corresponding to the appropriate authentication security level. In one example, the authentication platform retrieves initialization data (e.g., the “first set” of image data and responses) from the content storage element 130 and dynamically formulates one or more authentication challenges with a “second set” of image data selected from the first set, corresponding to the appropriate security level, for example, by selecting the number and/or type of individual challenges and the guidelines that correspond to the appropriate security level. In another example, the authentication platform maintains a database containing various preformulated protocols (e.g., identifying a number and/or type of individual challenges and guidelines) and selects the appropriate protocol from the database.

Finally, at step 408, the application platform applies the identified protocol to authenticate the user and grant access to the resource (if the authentication is “passed”) or rejects the user authentication and denies user access to the resource if the authentication fails.

The authentication embodiments described herein are difficult or impossible to circumvent with “fake” responses, since they are based on biometric authentication data that is advantageously outside the conscious control of the user. Therefore, it would be difficult or impossible to circumvent by physical coercion (e.g., by a third party forcing the user to undertake the authentication protocol), since a user under influence of physical coercion would likely be in a state of mind that would render his or her physiological responses significantly different (e.g., due to fear or nervousness, creating a rapid heart rate or the like) than the responses obtained in the initialization phase. Similarly, a user attempting to gain access to the resource for malicious purposes might be fearful or nervous, rendering his or her physiological responses significantly different than the responses obtained in the initialization phase. Further, the authentication protocol described herein may be easily revoked and “reissued” as needed or desired, any number of times, by repeating the initialization phase with new images. The authentication protocol thus overcomes many of the problems associated with prior art biometric authentication mechanisms.

FIGS. 1-4 and the foregoing description depict specific exemplary embodiments of the invention to teach those skilled in the art how to make and use the invention. The described embodiments are to be considered in all respects only as illustrative and not restrictive. The present invention may be embodied in other specific forms without departing from the scope of the invention which is indicated by the appended claims. All changes that come within the meaning and range of equivalency of the claims are to be embraced within their scope.

For example, the term “external stimuli” has been described with reference to specific exemplary embodiments, wherein a user is exposed to “image data” (i.e., visual stimuli) coincident to respective initialization and authentication protocols and the user's physiological reactions to the image data are obtained. As will be appreciated, the image data may comprise virtually any image content modality, including without limitation, “real” images (i.e., displaying physical objects), photographic images, holographic images, animated images, video content, alpha-numeric characters and/or colors or combinations thereof. Moreover, the term “external stimuli” is not limited to image data, but may comprise, separately or in combination with visual stimuli: audio, tactile, olfactory or any other sensory stimuli from which a user's physiological reactions may be obtained.

It should be understood that the term “processor” as used herein is intended to include one or more processing devices, including a central processing unit (CPU) or other processing circuitry, including but not limited to one or more signal processors, one or more integrated circuits, and the like. Also, the term “memory” as used herein is intended to include memory associated with a processor or CPU, such as RAM, ROM, a fixed memory device (e.g., hard drive), or a removable memory device (e.g., diskette or CDROM).

1. An apparatus comprising:
a memory; and
at least one processor coupled to the memory and configured to:
coincident to an initialization protocol, obtain biometric initialization data characterizing at least in part, a user's physiological responses to a first set of external stimuli;
coincident to an authentication protocol:
obtain biometric authentication data characterizing at least in part, a user's physiological responses to a second set of external stimuli, wherein the second set includes one or more instances of external stimuli selected from the first set;
compare the biometric authentication data to corresponding instances of the biometric initialization data; and
authenticate the user if one or more instances of the biometric authentication data sufficiently corresponds to corresponding instances of the biometric initialization data.

2. The apparatus of claim 1, wherein the processor resides in one or more of:
a user platform;
a trusted external platform; and
an authentication platform residing remotely from the user platform.

3. The apparatus of claim 2, wherein the processor resides in the authentication platform, and wherein:
coincident to the initialization protocol, the processor is configured to receive the biometric initialization data from one of the user platform and external platform, the one of the user platform and external platform having issued one or more initialization challenges, whereby the user is exposed to the first set of external stimuli, and whereby the user's physiological responses to the first set of external stimuli are measured to obtain the biometric initialization data.

4. The apparatus of claim 2, wherein the processor resides in one of the user platform and external platform, and wherein:
coincident to the initialization protocol, the processor is configured to issue one or more initialization challenges, whereby the user is exposed to the first set of external stimuli, and whereby the user's physiological responses to the first set of external stimuli are measured to obtain the biometric initialization data.

5. The apparatus of claim 2, wherein the processor resides in the authentication platform, and wherein coincident to the authentication protocol, the processor is configured to:
identify the second set of external stimuli;
instruct one of the user platform and external platform to issue one or more authentication challenges, whereby the user is to be exposed to the second set of external stimuli, and whereby the user's physiological responses to the second set of external stimuli are measured to obtain the biometric authentication data; and
receive the biometric authentication data from one of the user platform and external platform.

6. The apparatus of claim 2, wherein the processor resides in the authentication platform, and wherein coincident to the authentication protocol, the processor is configured to receive the biometric authentication data from one of the user platform and external platform, the one of the user platform and external platform having identified the second set of external stimuli and having issued one or more authentication challenges, whereby the user is exposed to the second set of external stimuli, and whereby the user's physiological responses to the second set of external stimuli are measured to obtain the biometric initialization data.

7. The apparatus of claim 2, wherein the processor resides in one of the user platform and external platform, and wherein:
coincident to the authentication protocol, the processor is configured to issue one or more authentication challenges, whereby the user is exposed to the second set of external stimuli, and whereby the user's physiological responses to the second set of external stimuli are measured to obtain the biometric initialization data.

8. A method, performed by one or more of a user platform, a trusted external platform, and an authentication platform residing remotely from the user platform, comprising:
coincident to an initialization protocol, obtaining biometric initialization data characterizing at least in part, a user's physiological responses to a first set of external stimuli;
coincident to an authentication protocol:
obtaining biometric authentication data characterizing at least in part, a user's physiological responses to a second set of external stimuli, wherein the second set includes one or more instances of external stimuli selected from the first set;
comparing the biometric authentication data to corresponding instances of the biometric initialization data; and
authenticating the user if one or more instances of the biometric authentication data sufficiently corresponds to corresponding instances of the biometric initialization data.

9. The method of claim 8, performed by the authentication platform, wherein:
coincident to the initialization protocol, the authentication platform receives the biometric initialization data from one of the user platform and external platform, the one of the user platform and external platform having issued one or more initialization challenges, whereby the user is exposed to the first set of external stimuli, and whereby the user's physiological responses to the first set of external stimuli are measured to obtain the biometric initialization data.

10. The method of claim 8, performed by one of the user platform and external platform, wherein:
coincident to the initialization protocol, the one of the user platform and external platform issues one or more initialization challenges, whereby the user is exposed to the first set of external stimuli, and whereby the user's physiological responses to the first set of external stimuli are measured to obtain the biometric initialization data.

11. The method of claim 8, performed by the authentication platform, wherein coincident to the authentication protocol, the authentication platform:
identifies the second set of external stimuli;
instructs one of the user platform and external platform to issue one or more authentication challenges, whereby the user is to be exposed to the second set of external stimuli, and whereby the user's physiological responses to the second set of external stimuli are measured to obtain the biometric authentication data; and
receives the biometric authentication data from one of the user platform and external platform.

12. The method of claim 8, performed by the authentication platform, wherein coincident to the authentication protocol, the authentication platform:
receives the biometric authentication data from one of the user platform and external platform, the one of the user platform and external platform having identified the second set of external stimuli and having issued one or more authentication challenges, whereby the user is exposed to the second set of external stimuli, and whereby the user's physiological responses to the second set of external stimuli are measured to obtain the biometric initialization data.

13. The method of claim 8, performed by one of the user platform and external platform, wherein:
coincident to the authentication protocol, the one of the user platform and external platform issues one or more authentication challenges, whereby the user is exposed to the second set of external stimuli, and whereby the user's physiological responses to the second set of external stimuli are measured to obtain the biometric initialization data.

14. A method, performed by an authentication platform, comprising:
receiving indicia of an access control event, whereby authentication is required for controlling user access to a resource;
identifying an authentication security level associated with the event;
identifying a stimuli-response-based authentication protocol corresponding to the authentication security level; and
applying the stimuli-response-based authentication protocol to determine user access to the resource.

15. The method of claim 14, wherein the step of identifying a protocol comprises the authentication platform:
dynamically formulating one or more stimuli-response-based authentication challenges defining the protocol.

16. The method of claim 14, wherein the step of identifying a protocol comprises the authentication platform:
maintaining a database of authentication protocols characterizing multiple authentication security levels; and
selecting a protocol having an authentication security level meeting or exceeding the authentication security level of the event.

17. The method of claim 14, wherein the step of identifying a protocol comprises the authentication platform:
obtaining biometric initialization data characterizing at least in part, a user's physiological responses to a first set of external stimuli;
identifying a plurality of authentication stimuli, wherein the authentication stimuli includes one or more instances of external stimuli selected from the first set and coincident to the authentication protocol, biometric authentication data is obtained characterizing at least in part, the user's physiological responses to the authentication stimuli; and
identifying authentication criteria based on a degree of correspondence required between the biometric authentication data and corresponding instances of the biometric initialization data.
